(19) United States
(12) Patent Application Publication
(10) Pub. No.: US 2020/0401937 A1
(43) Pub. Date: Dec. 24, 2020

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventor: Kengo TOKUCHI, Kanagawa (JP)

(73) Assignee: FUJI XEROX CO., LTD., Tokyo (JP)

(21) Appl. No.: 16/592,829

(22) Filed: Oct. 4, 2019

(30) Foreign Application Priority Data
Jun. 20, 2019 (JP) 2019-114386

(51) Int. Cl. G06N 20/00

(52) U.S. Cl. CPC G06N 20/00

(57) ABSTRACT

An information processing apparatus includes a transmitting unit that transmits, to an external apparatus, environment information indicative of an environment of an apparatus that uses an artificial intelligence and checking information for checking estimation processing of the artificial intelligence; a receiving unit that receives evaluation result information indicative of a result of evaluation of the estimation processing; and a controller that sets the estimation processing active in a case where the result of the evaluation is compliant with the environment. A criterion for the evaluation of the estimation processing varies according to the environment indicated by the environment information.

### CROSS-REFERENCE TO RELATED APPLICATIONS

This application is based on and claims priority under 35 USC 119 from Japanese Patent Application No. 2019-114386 filed Jun. 20, 2019.

### BACKGROUND

### (i) Technical Field

The present disclosure relates to an information processing apparatus and a non-transitory computer readable medium.

### (ii) Related Art

Japanese Unexamined Patent Application Publication No. 2019-16359 describes a method for screening a medical candidate material by loading data of available database into artificial intelligence that has learned to get a correct answer through deep learning and then making an inquiry.

Japanese Unexamined Patent Application Publication No. 2005-301582 describes an apparatus that estimates a failure factor by statistically analyzing several variables obtained by measuring a process by using an analysis parameter, reducing the number of variables and generating statistical analysis data, analyzing the statistical analysis data by using a determination parameter obtained by learning processing, and determining the presence or absence of an abnormality.

Japanese Unexamined Patent Application Publication No. 2018-151959 describes an apparatus that determines whether or not operation or a state of a target to be controlled by artificial intelligence is operation or a state that has a possibility of causing an undesirable result.

Japanese Unexamined Patent Application Publication No. 2018-85136 describes a system that has a first artificial intelligence module that includes a function of assisting or autonomously performing information exchange in an open environment and a second artificial intelligence module that monitors operation of the first artificial intelligence module and autonomously performs processing that accompanies the information exchange in a closed environment.

### SUMMARY

Aspects of non-limiting embodiments of the present disclosure relate to allowing artificial intelligence that is compliant with an environment to operate.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including: a transmitting unit that transmits, to an external apparatus, environment information indicative of an environment of an apparatus that uses an artificial intelligence and checking information for checking estimation processing of the artificial intelligence; a receiving unit that receives evaluation result information indicative of a result of evaluation of the estimation processing; and a controller that sets the estimation processing active in a case where the result of the evaluation is compliant with the environment, wherein a criterion for the evaluation of the estimation processing varies according to the environment indicated by the environment information.

### BRIEF DESCRIPTION OF THE DRAWINGS

An exemplary embodiment of the present disclosure will be described in detail based on the following figures, wherein:

FIG. 1 is a block diagram illustrating a configuration of an information processing system according to the present exemplary embodiment;

FIG. 2 is a block diagram illustrating a configuration of a terminal apparatus according to the present exemplary embodiment;

FIG. 3 is a block diagram illustrating a configuration of a determining apparatus according to the present exemplary embodiment;

FIG. 4 is a sequence diagram illustrating an outline of processing of the information processing system according to the present exemplary embodiment;

FIG. 5 is a flowchart illustrating processing according to a first example;

FIG. 6 is a flowchart illustrating processing according to a second example;

FIG. 7 is a flowchart illustrating processing according to a third example;

FIG. 8 is a view for explaining processing according to the third example;

FIG. 9 is a view for explaining processing according to the third example;

FIG. 10 is a view for explaining processing according to a second modification;

FIG. 11 is a view for explaining processing according to the second modification;

FIG. 12 illustrates a database for managing an effect of learning; and

FIG. 13 illustrates a database for managing an effect of learning.

### DETAILED DESCRIPTION

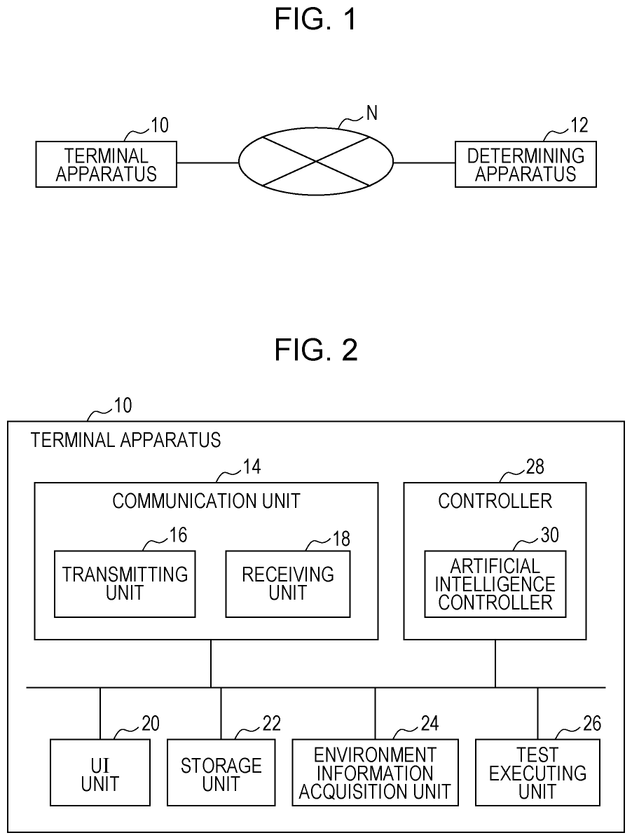

An information processing system according to the present exemplary embodiment is described with reference to FIG. 1. FIG. 1 illustrates an example of a configuration of the information processing system according to the present exemplary embodiment.

The information processing system according to the present exemplary embodiment includes one or more terminal apparatuses 10 and a determining apparatus 12. The information processing system may include an apparatus other than these apparatuses. The terminal apparatus 10 is an example of an information processing apparatus, and the determining apparatus 12 is an example of an external apparatus.

The terminal apparatus 10 and the determining apparatus 12 may communicate with another apparatus through a communication path N. The communication path N is, for example, a network such as a local area network (LAN) or the Internet. The communication path N may be constructed by wired communication or may be constructed by wireless communication such as Wi-Fi (Registered Trademark). The terminal apparatus 10 and the determining apparatus 12 are connected to the communication path N, for example, by using wireless communication or wired communication and communicate with another apparatus through the communication path N. The terminal apparatus 10 and the determining apparatus 12 may communicate with another apparatus, for example, by using short-range wireless communication without using the communication path N. The short-range wireless communication is, for example, Bluetooth (Registered Trademark), Radio Frequency Identifier (RFID), or NFC.

The terminal apparatus 10 is an example of an apparatus that uses artificial intelligence (i.e., AI). The terminal apparatus 10 is, for example, a personal computer (hereinafter referred to as a “PC”), a tablet PC, a smartphone, a mobile phone, or any of other kinds of apparatuses (e.g., a multifunctional printer having a scanner, a printer, and the like). These apparatuses are merely examples of the terminal apparatus 10.

An algorithm used in artificial intelligence is not limited in particular and may be any algorithm. The algorithm is, for example, machine learning. The machine learning may be supervised learning, or may be unsupervized learning, or may be reinforcement learning. Specifically, deep learning (e.g., multi-layer perceptron, convolutional neural network, recurrent neural network, autoencoder, restricted boltzmann machine), perceptron, back propagation, associatron, support vector machine, decision tree, k-nearest neighbor algorithm, linear regression, self-organizing map, boltzmann machine, principal component analysis, cluster analysis, Q-learning, or the like may be used. A genetic algorithm, a hill climbing method, or the like, which is an algorithm other than machine learning, may be used. Needless to say, an algorithm other than these algorithms may be used.

Artificial intelligence may be mounted in the terminal apparatus 10 or may be mounted in another apparatus (e.g., a server or a PC) other than the terminal apparatus 10. That is, a program for realizing artificial intelligence may be installed in the terminal apparatus 10 or may be installed in another apparatus other than the terminal apparatus 10. In a case where artificial intelligence is mounted in another apparatus other than the terminal apparatus 10 and where the artificial intelligence is used by the terminal apparatus 10, a processing result, service, and the like of the artificial intelligence mounted in the other apparatus are supplied to the terminal apparatus 10. For example, the processing result and the like are displayed on the terminal apparatus 10.

The determining apparatus 12 is an apparatus that is configured to evaluate performance of artificial intelligence. More specifically, the determining apparatus 12 is an apparatus that determines whether or not performance of the artificial intelligence satisfies a predetermined criterion. The determining apparatus 12 determines, for example, whether or not performance of the artificial intelligence used by the terminal apparatus 10 satisfies a predetermined criterion. The determining apparatus 12 is, for example, a PC, a tablet PC, a smartphone, a mobile phone, or any of other kinds of apparatuses (e.g., a server). Needless to say, these apparatuses are merely examples of the determining apparatus 12.

A configuration of the terminal apparatus 10 is described below in detail with reference to FIG. 2. FIG. 2 illustrates an example of a configuration of the terminal apparatus 10.

A communication unit 14 is a communication interface and has a function of transmitting information to another apparatus and a function of receiving information from another apparatus. The communication unit 14 may have a wireless communication function or may have a wired communication function. The communication unit 14 may communicate with another apparatus through the communication path N by using wireless communication or wired communication or may communicate with another apparatus without the communication path N, for example, by using close-range wireless communication. The communication unit 14 includes a transmitting unit 16 and a receiving unit 18.

The transmitting unit 16 is configured to transmit information to another apparatus. For example, the transmitting unit 16 is configured to transmit checking information for checking estimation processing of the artificial intelligence used by the terminal apparatus 10 that is a host device to the determining apparatus 12 that is an example of an external apparatus.

The estimation processing of the artificial intelligence is, for example, processing such as processing for estimating contents of data performed by the artificial intelligence, processing for making a judgment based on data performed by the artificial intelligence, or processing for providing information performed by the artificial intelligence. Specifically, character recognizing processing for recognizing a character represented by data, processing for estimating meaning of a character string, image recognizing processing for recognizing an object represented by image data, voice recognizing processing for recognizing voice, object recognizing processing for recognizing a physical object, translation processing, processing that demonstrates creativity (e.g., processing that demonstrates creativity in a field such as business or art), and processing for solving a problem (e.g., processing for solving a problem in a field such as business) are examples of the estimation processing of the artificial intelligence. Needless to say, these kinds of processing are merely examples of the estimation processing of the artificial intelligence, and other kinds of processing may be encompassed within the scope of the concept of the estimation processing of the artificial intelligence. For example, a known algorithm may be used as an algorithm for realizing the estimation processing of the artificial intelligence.

The checking information is information used by the determining apparatus 12 to check the estimation processing of the artificial intelligence. The checking information is, for example, answer information indicative of an answer of the artificial intelligence to a check test for checking whether or not performance of the artificial intelligence satisfies a predetermined criterion. That is, the transmitting unit 16 transmits the answer information to the determining apparatus 12. Check test data representing contents of the check test is transmitted from the determining apparatus 12 to the terminal apparatus 10.

The check test includes, for example, a question text, an image concerning a question, and voice concerning a question. The check test may be answered by selecting a correct answer from among plural options (e.g., character strings, images, voice), may be answered by writing an answer, or may be answered by uttering an answer as voice. The artificial intelligence answers one or more problems included in the check test.

The determining apparatus 12 checks whether or not performance of the artificial intelligence satisfies a predetermined criterion on the basis of the answer information. For example, in a case where the answer of the artificial intelligence to the check test satisfies an acceptance criterion of the check test, the determining apparatus 12 determines that performance of the artificial intelligence satisfies the predetermined criterion. In a case where the answer of the artificial intelligence to the check test does not satisfy an acceptance criterion of the check test, the determining apparatus 12 determines that the performance of the artificial intelligence does not satisfy the predetermined criterion. Needless to say, the determining apparatus 12 may evaluate performance of artificial intelligence by other methods.

The receiving unit 18 is configured to receive information transmitted from another apparatus to the terminal apparatus 10. For example, the receiving unit 18 is configured to receive evaluation result information indicative of a result of evaluation of the estimation processing of the artificial intelligence from the determining apparatus 12. The result of evaluation of the estimation processing of the artificial intelligence is a result of determination as to whether or not performance of the artificial intelligence satisfies a predetermined criterion. The evaluation result information is information indicating whether or not performance of the artificial intelligence satisfies a predetermined criterion. Whether or not performance of the artificial intelligence satisfies a predetermined criterion is determined by the determining apparatus 12 on the basis of the answer information, and evaluation result information indicating whether or not performance of the artificial intelligence satisfies a predetermined criterion is transmitted from the determining apparatus 12 to the terminal apparatus 10. The receiving unit 18 receives the evaluation result information transmitted from the determining apparatus 12 to the terminal apparatus 10.

Furthermore, the receiving unit 18 is configured to receive check test data. For example, the transmitting unit 16 transmits information requesting acquisition of check test data to the determining apparatus 12. The check test data is transmitted from the determining apparatus 12 to the terminal apparatus 10 in response to the request, and the receiving unit 18 receives the check test data. For example, in a case where a user who uses the terminal apparatus 10 gives an instruction to acquire check test data by operating a UI unit 20, a case where the artificial intelligence is initially used by the terminal apparatus 10, or a case where a program of the artificial intelligence is installed in the terminal apparatus 10, the transmitting unit 16 transmits information requesting acquisition of check test data to the determining apparatus 12. In another example, the transmitting unit 16 may transmit information requesting acquisition of check test data to the determining apparatus 12 every time the artificial intelligence is used by the terminal apparatus 10 or may transmit information requesting acquisition of check test data to the determining apparatus 12 at a predetermined timing or at predetermined intervals.

The UI unit 20 is a user interface and includes a display and an operation unit. The display is a display device such as a liquid crystal display. The operation unit is an input unit such as a keyboard, an input key, or an operation panel. The UI unit 20 may be a UI unit such as a touch panel that serves as both of the display and the operation unit.

A storage unit 22 is one or more storage regions in which various kinds of information are stored. Each of the storage regions is constituted, for example, by one or more storage devices (e.g., a physical drive such as a hard disk drive or a memory) provided in the terminal apparatus 10. The program of the artificial intelligence may be stored in the storage unit 22.

An environment information acquisition unit 24 is configured to acquire environment information indicative of an environment of the terminal apparatus 10 that is a host apparatus.

The environment of the terminal apparatus 10 that is a host apparatus is, for example, communication used by the terminal apparatus 10 and a position of the terminal apparatus 10. The communication used by the terminal apparatus 10 is, for example, the Internet or another network used by the terminal apparatus 10. The position of the terminal apparatus 10 is, for example, a place of the terminal apparatus 10 or a country or a community in which the terminal apparatus 10 is used. The environment information includes information such as information indicative of communication used by the terminal apparatus 10 and information indicative of the position of the terminal apparatus 10.

The environment information acquisition unit 24 may acquire, as the environment information, the information indicative of the communication used by the terminal apparatus 10. In a case where the terminal apparatus 10 is connected to the Internet, the environment information acquisition unit 24 acquires, as the environment information, information indicating that the terminal apparatus 10 is connected to the Internet. In a case where the terminal apparatus 10 is connected to a local network (e.g., a LAN), the environment information acquisition unit 24 acquires, as the environment information, information indicating that the terminal apparatus 10 is connected to the local network. In a case where the terminal apparatus 10 is connected to both of the Internet and the local network, the environment information acquisition unit 24 acquires, as the environment information, information indicating that the terminal apparatus 10 is connected to both of the Internet and the local network. The environment information acquisition unit 24 may acquire, as the environment information, information concerning communication other than the aforementioned information. The information concerning communication is, for example, a communication speed, a communication fee, and the like.

The environment information acquisition unit 24 may acquire, as the environment information, position information indicative of the position of the terminal apparatus 10. The environment information acquisition unit 24 may acquire the position information of the terminal apparatus 10, for example, by using a global positioning system (GPS) or may acquire position information entered by a user by operating the UI unit 20. The environment information acquisition unit 24 may specify a country, a community, or the like in which the terminal apparatus 10 is used (i.e., a country, a community, or the like in which the terminal apparatus 10 is present) on the basis of the position information acquired by the GPS. In this case, information indicative of the specified country, community, or the like is included in the environment information. Needless to say, the user may designate the country, the community, or the like by operating the UI unit 20.

The transmitting unit 16 may transmit answer information that is checking information for checking the estimation processing of the artificial intelligence to the determining apparatus 12 and further transmit environment information indicative of the environment of the terminal apparatus 10 that is a host apparatus acquired by the environment information acquisition unit 24 to the determining apparatus 12.

A test executing unit 26 is configured to cause the artificial intelligence used by the terminal apparatus 10 to answer a check test represented by check test data. Furthermore, the test executing unit 26 is configured to create answer information indicative of the answer. In a case where the artificial intelligence used by the terminal apparatus 10 is artificial intelligence mounted in the terminal apparatus 10, the test executing unit 26 causes the artificial intelligence mounted in the terminal apparatus 10 to answer the check test. In a case where the artificial intelligence used by the terminal apparatus 10 is artificial intelligence mounted in an apparatus (e.g., a server) other than the terminal apparatus 10, the test executing unit 26 causes the artificial intelligence mounted in the other apparatus to answer the check test.

When the check test is executed and answer information is created, the transmitting unit 16 transmits the answer information that is checking information to the determining apparatus 12. Performance of the artificial intelligence is evaluated by the determining apparatus 12 on the basis of the answer indicated by the answer information, and evaluation result information indicative of a result of the evaluation of the performance of the artificial intelligence is transmitted from the determining apparatus 12 to the terminal apparatus 10. The receiving unit 18 receives the evaluation result information.

In a case where a predetermined period has elapsed from a time of execution of the check test, the test executing unit 26 may execute a check test again. That is, in a case where a predetermined period has elapsed from a time at which the artificial intelligence answers the check test, the test executing unit 26 may cause the artificial intelligence to answer a check test again. In this case, the transmitting unit 16 transmits information indicative of a request for a new check test to the determining apparatus 12, and the receiving unit 18 receives check test data transmitted from the determining apparatus 12 in response to the request. The test executing unit 26 causes the artificial intelligence to answer a check test represented by the check test data. Note that check test data already received by the receiving unit 18 may be stored in the storage unit 22. In this case, the test executing unit 26 may cause the artificial intelligence to answer a check test represented by the check test data stored in the storage unit 22.

The test executing unit 26 may cause the artificial intelligence to answer a check test in a case where the user gives an instruction to execute the check test by operating the UI unit 20 or may automatically cause the artificial intelligence to answer the check test irrespective of a user's instruction. For example, the test executing unit 26 may cause the artificial intelligence to answer a check test, for example, in a case where the artificial intelligence is initially used by the terminal apparatus 10 or in a case where the program of the artificial intelligence is installed in the terminal apparatus 10. In another example, the test executing unit 26 may cause the artificial intelligence to answer a check test every time the artificial intelligence is used by the terminal apparatus 10 or may cause the artificial intelligence to answer a check test at a predetermined timing or at predetermined intervals. In a case where check test data is stored in the storage unit 22, the test executing unit 26 may cause the artificial intelligence to answer a check test represented by the check test data. In another example, in a case where a check test is executed, the transmitting unit 16 may transmit information requesting acquisition of check test data to the determining apparatus 12 irrespective of whether or not check test data is stored in the storage unit 22, and the receiving unit 18 may receive the check test data transmitted from the determining apparatus 12 to the terminal apparatus 10 in response to the request. In this case, the test executing unit 26 causes the artificial intelligence to answer a check test represented by the check test data received by the receiving unit 18.

In a case where the receiving unit 18 receives check test data, the test executing unit 26 causes the artificial intelligence to answer the check test even in a case where the artificial intelligence is executing operation other than answering a check test. This makes it possible to check whether or not performance of the artificial intelligence satisfies a predetermined criterion by forcibly causing the artificial intelligence to answer a check test even in a case where the artificial intelligence is executing the other operation.

In a case where a check test is not executed by the test executing unit 26, i.e., in a case where the test executing unit 26 does not cause the artificial intelligence to answer a check test, the transmitting unit 16 may transmit information concerning the artificial intelligence to the determining apparatus 12. The information concerning the artificial intelligence includes, for example, information such as information for identifying the artificial intelligence and information indicating that a check test has not been executed for the artificial intelligence. Furthermore, the information concerning the artificial intelligence may include information such as information indicative of a length of a period in which a check test is not executed for the artificial intelligence, information indicative of a reason why the check test is not executed, information for identifying the terminal apparatus 10 using the artificial intelligence, and information for identifying a user using the artificial intelligence. Examples of the case where a check test is not executed include a case where the user has forcibly stopped execution of the check test, a case where check test data has been deleted, and a case where a failure has occurred in the check test.

In a case where plural artificial intelligences are used, the test executing unit 26 may execute a check test for each of the plural artificial intelligences. For example, in a case where plural artificial intelligences are mounted in the terminal apparatus 10, the test executing unit 26 executes a check test for each of the plural artificial intelligences. For example, also in a case where plural artificial intelligences mounted in an apparatus such as a server are used or in a case where one or more of plural used artificial intelligences are mounted in the terminal apparatus 10 and the other artificial intelligence is mounted in an apparatus such as a server, the test executing unit 26 may execute a check test for each of the plural artificial intelligences.

The controller 28 is configured to control operation of each unit of the terminal apparatus 10. Furthermore, the controller 28 includes an artificial intelligence controller 30.

The artificial intelligence controller 30 is configured to control artificial intelligence used by the terminal apparatus 10 on the basis of an evaluation result indicated by evaluation result information.

For example, the artificial intelligence controller 30 permits operation of the artificial intelligence in a case where an answer of the artificial intelligence satisfies an acceptance criterion concerning a check test. For example, the artificial intelligence controller 30 sets the estimation processing of the artificial intelligence active. In this case, the artificial intelligence can execute the estimation processing.

In a case where the answer of the artificial intelligence does not satisfy the acceptance criterion, the artificial intelligence controller 30 restricts operation of the artificial intelligence. For example, the artificial intelligence controller 30 entirely or partially prohibits operation of the artificial intelligence. Specifically, the artificial intelligence controller 30 sets all or part of the estimation processing of the artificial intelligence inactive. In this case, the artificial intelligence cannot execute all or part of the estimation processing. Alternatively, the artificial intelligence controller 30 may stop operation of the artificial intelligence.

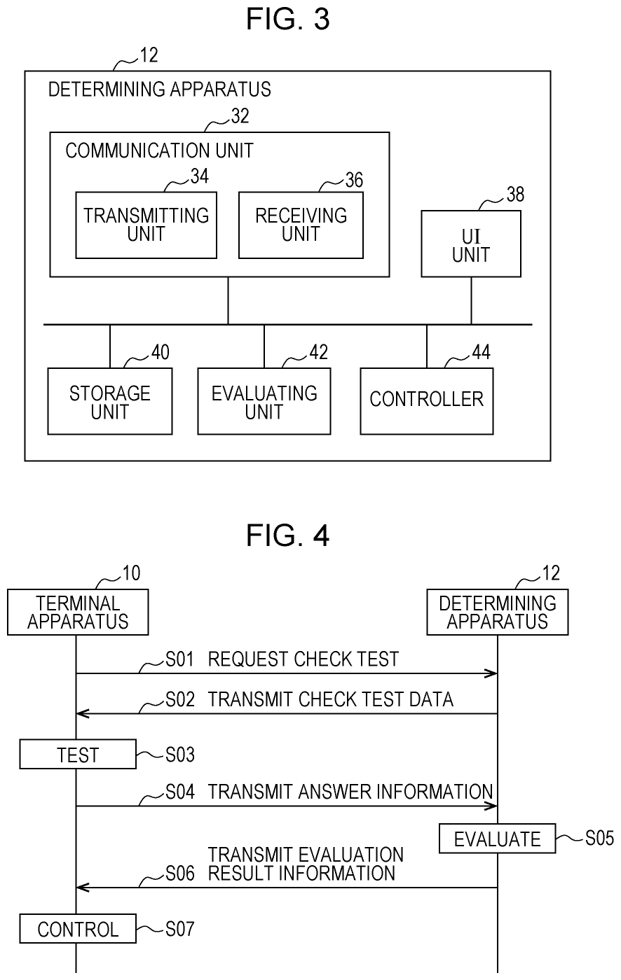

A configuration of the determining apparatus 12 is described in detail below with reference to FIG. 3. FIG. 3 illustrates an example of the configuration of the determining apparatus 12.

A communication unit 32 is a communication interface and has a function of transmitting information to another apparatus and a function of receiving information from another apparatus. The communication unit 32 may have a wireless communication function or may have a wired communication function. The communication unit 32 may communicate with another apparatus through the communication path N by using wireless communication or wired communication or may communicate with another apparatus without the communication path N, for example, by using close-range wireless communication. The communication unit 32 includes a transmitting unit 34 and a receiving unit 36.

The transmitting unit 34 is configured to transmit information to another apparatus. For example, the transmitting unit 34 is configured to transmit check test data to the terminal apparatus 10 that has requested acquisition of the check test data. For example, in a case where information requesting acquisition of check test data is transmitted from the terminal apparatus 10 to the determining apparatus 12, the transmitting unit 34 transmits the check test data to the terminal apparatus 10 in response to the request.

The receiving unit 36 is configured to receive information transmitted from another apparatus to the determining apparatus 12. For example, the receiving unit 36 is configured to receive, from the terminal apparatus 10, information such as information requesting acquisition of check test data, environment information indicative of an environment of the terminal apparatus 10, and answer information that is checking information.

A UI unit 38 is a user interface and includes a display and an operation unit. The display is a display device such as a liquid crystal display. The operation unit is an input device such as a keyboard, an input key, and an operation panel. The UI unit 38 may be a UI unit such as a touch panel that serves as both of the display and the operation unit.

A storage unit 40 is one or more storage regions in which various kinds of information are stored. Each of the storage regions is constituted, for example, by one or more storage devices (e.g., a physical drive such as a hard disk drive or a memory) provided in the determining apparatus 12.

Check test data is stored in the storage unit 40. The transmitting unit 34 transmits the check test data stored in the storage unit 40 to the terminal apparatus 10 that has requested acquisition of the check test data in response to the request for acquisition of the check test data.

Check test data may be stored in another apparatus (e.g., a server) other than the determining apparatus 12 instead of being stored in the storage unit 40 or in addition to being stored in the storage unit 40. In this case, a controller 44 acquires the check test data stored in the other apparatus in response to a request for acquisition of checking data, and the transmitting unit 34 transmits the check test data acquired from the other apparatus to the terminal apparatus 10 that has requested acquisition of the check test data.

An evaluating unit 42 is configured to evaluate performance of artificial intelligence. More specifically, the evaluating unit 42 is configured to determine whether or not performance of artificial intelligence satisfies a predetermined criterion on the basis of an answer of the artificial intelligence to a check test. The answer of the artificial intelligence is indicated by answer information received from the terminal apparatus 10 by the receiving unit 36. The evaluating unit 42 creates evaluation result information (i.e., information indicating whether or not performance of artificial intelligence satisfies a predetermined criterion) indicative of a result of evaluation of performance of the artificial intelligence. The transmitting unit 34 transmits the evaluation result information to the terminal apparatus 10 that has transmitted the answer information.

For example, an acceptance criterion concerning a check test is determined in advance, and information indicative of the acceptance criterion is stored in advance in the storage unit 40. In a case where an answer of the artificial intelligence to the check test satisfies the acceptance criterion concerning the check test, the evaluating unit 42 determines that performance of the artificial intelligence satisfies a predetermined criterion. In a case where the answer of the artificial intelligence to the check test does not satisfy the acceptance criterion concerning the check test, the evaluating unit 42 determines that performance of the artificial intelligence does not satisfy the predetermined criterion.

The evaluating unit 42, for example, determines whether or not an answer to a question to be answered by the artificial intelligence is correct and gives a score. For example, in a case where the score is equal to or higher than a predetermined threshold value of the acceptance criterion, the evaluating unit 42 determines that performance of the artificial intelligence satisfies a predetermined criterion. In a case where the score is less than the threshold value, the evaluating unit 42 determines that performance of the artificial intelligence does not satisfy the predetermined criterion. For example, in a case where the question is answered by selecting a correct answer from among plural options, the evaluating unit 42 determines whether or not the selection is correct and gives a score. In a case where there are plural problems to be answered by the artificial intelligence, the evaluating unit 42 determines whether or not an answer to each of the questions is correct and determines whether or not performance of the artificial intelligence satisfies a predetermined criterion by comparing a total score and a threshold value. In a case where the question is answered by writing an answer, the evaluating unit 42 analyzes contents of the written answer and determines whether or not the contents are correct. In a case where the contents are correct, the evaluating unit 42 determines that performance of the artificial intelligence satisfies the predetermined criterion. In a case where the contents are incorrect, the evaluating unit 42 determines that performance of the artificial intelligence does not satisfy the predetermined criterion.

The evaluating unit 42 may give a rank (e.g., a rank A, B, C, or D) to an answer of the artificial intelligence to a check test. For example, the rank A corresponds to highest evaluation (e.g., a case where a score of the answer to the check test is equal to or higher than an upper-limit value), and the rank D corresponds to lowest evaluation (e.g., a case where the score of the answer to the check test is less than a lower-limit value). The ranks B and C are evaluation between the ranks A and D, and the rank B corresponds to evaluation higher than the rank C. The evaluating unit 42 decides a rank according to the score of the answer to the check test. Information indicative of the rank and information indicative of the score are included in the evaluation result information and are transmitted from the determining apparatus 12 to the terminal apparatus 10.

The artificial intelligence controller 30 of the terminal apparatus 10 may control the artificial intelligence in accordance with the rank and the score indicated by the evaluation result information. For example, the artificial intelligence controller 30 permits execution of more operations and functions as the rank and the score become higher and restricts execution of more operations and functions as the rank and the score become lower. For example, the artificial intelligence controller 30 permits all operations and functions of the artificial intelligence in a case where the rank is the rank A, stops the operations of the artificial intelligence in a case where the rank is the rank D, and restricts the operations and functions in accordance with the rank in a case where the rank is the rank C or the rank D.

The controller 44 is configured to control operation of each unit of the determining apparatus 12.

An outline of processing of the information processing system according to the present exemplary embodiment is described below with reference to FIG. 4. FIG. 4 is a sequence diagram illustrating an outline of the processing.

First, the terminal apparatus 10 transmits information requesting acquisition of check test data to the determining apparatus 12 (S01). The determining apparatus 12 that has received the information transmits the check test data to the terminal apparatus 10 in response to the request (S02). In a case where the check test data is stored in the terminal apparatus 10, the processes in steps S01 and S02 are omitted. The terminal apparatus 10 that has received the check test data executes a check test (S03). That is, the terminal apparatus 10 causes the artificial intelligence used by the terminal apparatus 10 to answer a check test represented by the check test data. Next, the terminal apparatus 10 transmits answer information indicative of an answer of the artificial intelligence to the check test to the determining apparatus 12 (S04). The determining apparatus 12 that has received the answer information evaluates performance of the artificial intelligence on the basis of the answer indicated by the answer information (S05). Next, the determining apparatus 12 transmits evaluation result information indicative a result of the evaluation to the terminal apparatus 10 (S06). The terminal apparatus 10 that has received the evaluation result information controls the artificial intelligence used by the terminal apparatus 10 on the basis of the evaluation result indicated by the evaluation result information (S07).

The information processing system according to the present exemplary embodiment is described in more detail below.

A check test according to the environment of the terminal apparatus 10 may be executed. That is, the test executing unit 26 may cause the artificial intelligence used by the terminal apparatus 10 to answer the check test according to the environment of the terminal apparatus 10.

The check test according to the environment of the terminal apparatus 10 is a test for checking whether or not performance of the artificial intelligence satisfies a predetermined criterion in compliance with the environment and is a test including a question concerning the environment. Specifically, the check test is a check test concerning communication used by the terminal apparatus 10 or a check test concerning the position of the terminal apparatus 10.

For example, in a case where the terminal apparatus 10 is connected to the Internet, a test (hereinafter referred to as a “check test for Internet”) for checking capability of judgment that should be satisfied by the artificial intelligence in a case where the terminal apparatus 10 is connected to the Internet is an example of the check test according to the communication used by the terminal apparatus 10. The check test for Internet includes, for example, a question concerning the Internet, a question concerning a matter to be noted for use of the Internet, a question concerning security of the Internet, and the like. For example, the check test for Internet includes a test for checking information such as information that may be sent over the Internet and information that cannot be sent over the Internet.

In a case where the terminal apparatus 10 is connected to the Internet and is connected to only a local network (e.g., a LAN), a test (hereinafter referred to as a “check test for local”) for checking capability of judgment that should be satisfied by the artificial intelligence in a case where the terminal apparatus 10 is connected to the local network is an example of the check test according to the communication used by the terminal apparatus 10. The check test for local includes, for example, a question concerning the local network, a question concerning a matter to be noted for use of the local network, a question concerning security of the local network, and the like. For example, the check test for local includes a test for checking information such as information that may be sent over the local network and information that cannot be sent over the local network.

In a case where the terminal apparatus 10 is used in a certain country, i.e., in a case where the position of the terminal apparatus 10 is located within the country, a test for checking capability of judgment that should be satisfied in the country by the artificial intelligence is an example of the check test according to the position of the terminal apparatus 10. For example, the check test includes a test concerning the country. Specifically, the check test includes a test for checking an act prohibited in the country, a religion of the country, a culture of the country, and the like.

To execute the check test according to the environment of the terminal apparatus 10, for example, the transmitting unit 16 of the terminal apparatus 10 transmits environment information indicative of the environment of the terminal apparatus 10 and information requesting acquisition of check test data to the determining apparatus 12.

In a case where the environment information indicative of the environment of the terminal apparatus 10 and the information requesting acquisition of the check test data are transmitted from the terminal apparatus 10 to the determining apparatus 12, the transmitting unit 34 of the determining apparatus 12 transmits the check test data indicative of a check test according to the environment of the terminal apparatus 10 to the terminal apparatus 10. For example, check test data for each environment is stored in the storage unit 40 of the determining apparatus 12 or another apparatus such as a server, and the transmitting unit 34 of the determining apparatus 12 transmits check test data according to the environment of the terminal apparatus 10 to the terminal apparatus 10.

The receiving unit 18 of the terminal apparatus 10 receives the check test data representing the check test according to the environment of the terminal apparatus 10 from the determining apparatus 12.

In a case where the receiving unit 18 of the terminal apparatus 10 receives the check test data representing the check test according to the environment of the terminal apparatus 10, the test executing unit 26 causes the artificial intelligence used by the terminal apparatus 10 to answer the check test according to the environment and creates answer information indicative of the answer. The answer information includes environment information indicative of the environment. The transmitting unit 16 of the terminal apparatus 10 transmits the answer information to the determining apparatus 12.

The evaluating unit 42 evaluates performance of the artificial intelligence used by the terminal apparatus 10 on the basis of the answer indicated by the answer information transmitted from the terminal apparatus 10. Different acceptance criteria may be set for different environments. In such case, a result of the evaluation may vary depending on the environment of the terminal apparatus 10. Information indicative of the acceptance criterion for each environment is stored in the storage unit 40 of the determining apparatus 12 or another apparatus such as a server. In a case where the answer of the artificial intelligence to the check test according to the environment of the terminal apparatus 10 satisfies an acceptance criterion according to the environment, the evaluating unit 42 determines that performance of the artificial intelligence satisfies a predetermined criterion in compliance with the environment. In a case where the answer does not satisfy the acceptance criterion according to the environment, the evaluating unit 42 determines that performance of the artificial intelligence does not satisfy the predetermined criterion in compliance with the environment. As described above, the evaluating unit 42 may give a rank according to the environment to the answer of the artificial intelligence.

The transmitting unit 34 of the determining apparatus 12 transmits evaluation result information indicative of the result of the evaluation of the evaluating unit 42 to the terminal apparatus 10. The receiving unit 18 of the terminal apparatus 10 receives the evaluation result information transmitted from the determining apparatus 12.

As described above, the artificial intelligence controller 30 controls the artificial intelligence used by the terminal apparatus 10 on the basis of the evaluation result indicated by the evaluation result information.

For example, in a case where the evaluation result is compliant with the environment of the terminal apparatus 10, the artificial intelligence controller 30 permits operation of the artificial intelligence without restricting operation of the artificial intelligence used by the terminal apparatus 10. In a case where the evaluation result is not compliant with the environment of the terminal apparatus 10, the artificial intelligence controller 30 restricts operation of the artificial intelligence used by the terminal apparatus 10.

The case where the evaluation result is compliant with the environment of the terminal apparatus 10 is a case where the answer of the artificial intelligence to the check test satisfies the acceptance criterion according to the environment of the terminal apparatus 10. The case where the evaluation result is not compliant with the environment of the terminal apparatus 10 is a case where the answer of the artificial intelligence to the check test does not satisfy the acceptance criterion according to the environment of the terminal apparatus 10.

For example, in a case where the terminal apparatus 10 is connected to the Internet and an answer of the artificial intelligence to the check test for Internet satisfies an acceptance criterion according to the environment that is the Internet, the artificial intelligence controller 30 permits operation of the artificial intelligence. In a case where the answer of the artificial intelligence does not satisfy the acceptance criterion according to the environment that is the Internet, the artificial intelligence controller 30 restricts operation of the artificial intelligence.

In a case where the terminal apparatus 10 is located within a certain country and an answer of the artificial intelligence to a check test concerning the country satisfies an acceptance criterion according to the country, the artificial intelligence controller 30 permits operation of the artificial intelligence. In a case where the answer of the artificial intelligence does not satisfy the acceptance criterion according to the country, the artificial intelligence controller 30 restricts operation of the artificial intelligence.

The above example is merely an example of processing for evaluating an answer to a check test according to an environment. In order to perform processing for evaluating an answer to a check test according to an environment, not a check test according to the environment of the terminal apparatus 10 but common check test data representing a common check test may be transmitted from the determining apparatus 12 to the terminal apparatus 10, and the receiving unit 18 of the terminal apparatus 10 may receive the common check test data. The common check test is a check test that does not depend on the environment of the terminal apparatus 10 and is, for example, a test including all of predetermined check tests concerning an environment. Specifically, the common check test includes a check test for Internet, a check test for local, check tests concerning respective countries and communities, and other check tests.

For example, the transmitting unit 16 of the terminal apparatus 10 transmits information requesting acquisition of the check test data to the determining apparatus 12. In this case, the transmitting unit 16 of the terminal apparatus 10 does not transmit environment information indicative of the environment of the terminal apparatus 10 to the determining apparatus 12.

The receiving unit 36 of the determining apparatus 12 receives the information requesting acquisition of the check test data from the terminal apparatus 10 and does not receive environment information, the transmitting unit 34 of the determining apparatus 12 transmits common check test data representing a common check test that does not depend on the environment of the terminal apparatus 10 to the terminal apparatus 10. The common check test data is stored in the storage unit 40 of the determining apparatus 12 or another apparatus such as a server.

In a case where the receiving unit 18 of the terminal apparatus 10 receives the common check test data representing the common check test that does not depend on the environment of the terminal apparatus 10, the test executing unit 26 causes the artificial intelligence used by the terminal apparatus 10 to answer the common check test and creates answer information indicative of the answer. The test executing unit 26 may cause the artificial intelligence used by the terminal apparatus 10 to answer all tests included in the common check test or may cause the artificial intelligence used by the terminal apparatus 10 to answer a test according to the environment of the terminal apparatus 10 included in the common check test. For example, in a case where the terminal apparatus 10 is connected to the Internet, the test executing unit 26 may cause the artificial intelligence used by the terminal apparatus 10 to answer the check test for Internet included in the common check test and need not cause the artificial intelligence used by the terminal apparatus 10 to answer the check test for local included in the common check test. In a case where the terminal apparatus 10 is located within a certain country, the test executing unit 26 may cause the artificial intelligence used by the terminal apparatus 10 to answer a check test concerning the country and need not cause the artificial intelligence used by the terminal apparatus 10 to answer a check test concerning a country other than the country.

The transmitting unit 16 of the terminal apparatus 10 transmits environment information indicative of the environment of the terminal apparatus 10 and answer information indicative of the answer to the common check test to the determining apparatus 12.

In a case where the environment information indicative of the environment of the terminal apparatus 10 and the answer information indicative of the answer to the common check test are transmitted from the terminal apparatus 10 to the determining apparatus 12, the evaluating unit 42 determines whether or not performance of the artificial intelligence satisfies a predetermined criterion in compliance with the environment on the basis of an acceptance criterion according to the environment and the answer to the test according to the environment included in the common check test. In a case where the answer to the test according to the environment satisfies the acceptance criterion according to the environment, the evaluating unit 42 determines that performance of the artificial intelligence satisfies the predetermined criterion in compliance with the environment. In a case where the answer to the test according to the environment does not satisfy the acceptance criterion according to the environment, the evaluating unit 42 determines that performance of the artificial intelligence does not satisfy the predetermined criterion in compliance with the environment. As described above, the evaluating unit 42 may give a rank and a score according to the environment in response to the answer of the artificial intelligence.

The transmitting unit 34 of the determining apparatus 12 transmits evaluation result information indicative of a result of the evaluation of the evaluating unit 42 to the terminal apparatus 10. The receiving unit 18 of the terminal apparatus 10 receives the evaluation result information transmitted from the determining apparatus 12.

As described above, the artificial intelligence controller 30 controls the artificial intelligence used by the terminal apparatus 10 on the basis of the evaluation result indicated by the evaluation result information.

The check test may be a test according to a field of use of the artificial intelligence or usage of the artificial intelligence. For example, in a case where the field of use of the artificial intelligence is a medical field, i.e., in a case where the artificial intelligence makes a medical judgment or provides medical information, a check test concerning a medical field is used. In this case, the test executing unit 26 causes the artificial intelligence used in the medical field to answer the check test concerning the medical field.

In order to execute a check test according to a field of use of the artificial intelligence or usage of the artificial intelligence, the transmitting unit 16 of the terminal apparatus 10 transmits information (hereinafter referred to as “field information”) indicative of the field of use of the artificial intelligence or usage of the artificial intelligence and information requesting acquisition of check test data to the determining apparatus 12. For example, in a case where the artificial intelligence is used in the medical field, the transmitting unit 16 of the terminal apparatus 10 transmits field information indicative of the medical field and information requesting acquisition of check test data to the determining apparatus 12. Note that the field of use of the artificial intelligence or usage of the artificial intelligence may be designated by user's operation of the UI unit 20 of the terminal apparatus 10 or information indicative of the field of use of the artificial intelligence or usage of the artificial intelligence may be associated in advance with the artificial intelligence.

In a case where the field information and the information requesting acquisition of check test data are transmitted from the terminal apparatus 10 to the determining apparatus 12, the transmitting unit 34 of the determining apparatus 12 transmits check test data representing a check test according to the field of use of the artificial intelligence or usage of the artificial intelligence to the terminal apparatus 10. For example, check test data for each field and check test data for each usage are stored in the storage unit 40 of the determining apparatus 12 or another apparatus such as a server, and the transmitting unit 34 of the determining apparatus 12 transmits the check test data according to the field of use of the artificial intelligence or usage of the artificial intelligence to the terminal apparatus 10.

The receiving unit 18 of the terminal apparatus 10 receives the check test data representing the check test according to the field of use of the artificial intelligence or usage of the artificial intelligence from the determining apparatus 12.

In a case where the receiving unit 18 of the terminal apparatus 10 receives the check test data representing the check test according to the field of use of the artificial intelligence or usage of the artificial intelligence, the test executing unit 26 causes the artificial intelligence used by the terminal apparatus 10 to answer the check test according to the field or usage and creates answer information indicative of the answer. The answer information includes environment information indicative of the field or usage. The transmitting unit 16 of the terminal apparatus 10 transmits the answer information to the determining apparatus 12.

The evaluating unit 42 evaluates performance of the artificial intelligence used by the terminal apparatus 10 on the basis of the answer indicated by the answer information transmitted from the terminal apparatus 10. A result of the evaluation is an evaluation result according to the field of use of the artificial intelligence or usage of the artificial intelligence and sometimes changes in accordance with the field or usage. An acceptance criterion for each field or an acceptance criterion for each usage is determined in advance, and information indicative of the acceptance criterion for each environment or information indicative of the acceptance criterion for each usage is stored in the storage unit 40 of the determining apparatus 12 or another apparatus such as a server. In a case where the answer of the artificial intelligence to the check test according to the field of use of the artificial intelligence or usage of the artificial intelligence satisfies the acceptance criterion according to the field or usage, the evaluating unit 42 determines that performance of the artificial intelligence satisfies a predetermined criterion in compliance with the field or usage. In a case where the answer does not satisfy the acceptance criterion according to the field or usage, the evaluating unit 42 determines that performance of the artificial intelligence does not satisfy the predetermined criterion in compliance with the field or usage. As described above, the evaluating unit 42 may give a rank and a score according to the field or usage to the answer of the artificial intelligence. In a case where the artificial intelligence is used in the medical field, the evaluating unit 42 evaluates performance of the artificial intelligence by using an acceptance criterion for the medical field. This also applies to a case where the artificial intelligence is used in another field (e.g., a business field, a translation field, an entertainment field).

The transmitting unit 34 of the determining apparatus 12 transmits evaluation result information indicative of a result of the evaluation of the evaluating unit 42 to the terminal apparatus 10. The receiving unit 18 of the terminal apparatus 10 receives the evaluation result information transmitted from the determining apparatus 12.

As described above, the artificial intelligence controller 30 controls the artificial intelligence used by the terminal apparatus 10 on the basis of the evaluation result indicated by the evaluation result information.

The artificial intelligence controller 30 may permit operation of the artificial intelligence only in a field for which performance of the artificial intelligence has satisfied a predetermined criterion among plural fields. For example, in a case where the answer of the artificial intelligence to the check test concerning the medical field satisfies the acceptance criterion according to the medical field and an answer of the artificial intelligence to a check test concerning a field other than the medical field does not satisfy an acceptance criterion according to the other field, the artificial intelligence controller 30 permits operation of the artificial intelligence only in the medical field and prohibits operation of the artificial intelligence in the other field. In this case, the artificial intelligence performs estimation processing only in the medical field and does not perform estimation processing in the other field.

In a case where a check test according to the field of use of the artificial intelligence or usage of the artificial intelligence is executed, common check test data may be transmitted from the determining apparatus 12 to the terminal apparatus 10, and the test executing unit 26 may cause the artificial intelligence to answer a common check test represented by the common check test data as in a case where a check test according to the environment of the terminal apparatus 10 is executed.

The common check test is a test that includes check tests concerning all of predetermined fields or usages. Specifically, the common check test includes a check test concerning a medical field and check tests concerning other fields or usages. The test executing unit 26 may cause the artificial intelligence to answer all of the tests included in the common check test or may cause the artificial intelligence to answer a test according to the field of use of the artificial intelligence or usage of the artificial intelligence among the tests included in the common check test. For example, in a case where the artificial intelligence is used in the medical field, the test executing unit 26 may cause the artificial intelligence to answer the check test concerning the medical field among the check tests included in the common check test and need not cause the artificial intelligence to answer check tests concerning fields or usages other than the medical field.

The transmitting unit 16 of the terminal apparatus 10 transmits field information indicative of the field of use of the artificial intelligence or usage of the artificial intelligence and answer information indicative of the answer to the common check test to the determining apparatus 12.

In a case where the field information and the answer information indicative of the answer to the common check test are transmitted from the terminal apparatus 10 to the determining apparatus 12, the evaluating unit 42 determines whether or not performance of the artificial intelligence satisfies a predetermined criterion in compliance with the field or usage on the basis of the acceptance criterion according to the field or usage indicated by the field information and the answer to the test according to the field or usage among the tests included in the common check tests. In a case where the answer to the test according to the field or usage satisfies an acceptance criterion according to the field or usage, the evaluating unit 42 determines that performance of the artificial intelligence satisfies a predetermined criterion in compliance with the field or usage. In a case where the answer to the test according to the field or usage does not satisfy the acceptance criterion according to the field or usage, the evaluating unit 42 determines that performance of the artificial intelligence does not satisfy the predetermined criterion in compliance with the field or usage. As described above, the evaluating unit 42 may give a rank and a score according to the field or usage to the answer of the artificial intelligence.

The transmitting unit 34 of the determining apparatus 12 transmits evaluation result information indicative of a result of the evaluation of the evaluating unit 42 to the terminal apparatus 10. The receiving unit 18 of the terminal apparatus 10 receives the evaluation result information transmitted from the determining apparatus 12.

As described above, the artificial intelligence controller 30 controls the artificial intelligence used by the terminal apparatus 10 on the basis of the evaluation result indicated by the evaluation result information.

Processing of the information processing system according to the present exemplary embodiment is described in detail below by using specific examples.

### First Example

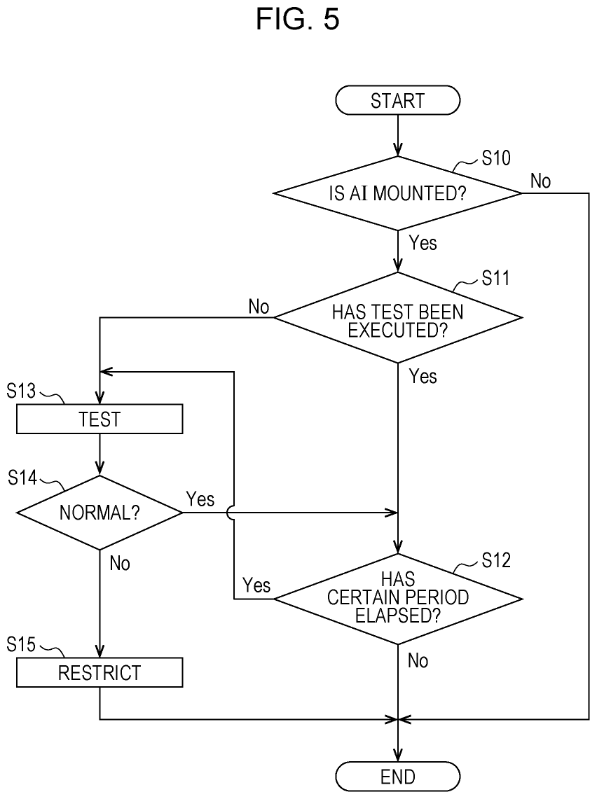

Processing according to a first example is described with reference to FIG. 5. FIG. 5 is a flowchart illustrating the processing according to the first example.

First, the test executing unit 26 checks whether or not artificial intelligence (“AI” in FIG. 5) is mounted in the terminal apparatus 10 (S10). For example, in a case where a program for realizing artificial intelligence is installed in the terminal apparatus 10, the test executing unit 26 determines that the artificial intelligence is mounted in the terminal apparatus 10. In a case where a program for realizing artificial intelligence is not installed in the terminal apparatus 10, the test executing unit 26 determines that the artificial intelligence is not mounted in the terminal apparatus 10.

In a case where artificial intelligence is not mounted in the terminal apparatus 10 (No in S10), the processing is finished since a check test need not be executed.

In a case where artificial intelligence is mounted in the terminal apparatus 10 (Yes in S10), the test executing unit 26 checks whether or not a check test has been already executed (S11). That is, the test executing unit 26 checks whether or not the artificial intelligence has already answered the check test.

Although whether or not the artificial intelligence is mounted in the terminal apparatus 10 is checked in this example, it may be checked whether or not an entity that offers a function, service, or the like used by the terminal apparatus 10 is artificial intelligence. For example, in a case where a function, service, or the like offered by another apparatus such as a server is used by the terminal apparatus 10, it may be checked whether or not the function, the service, or the like is offered by artificial intelligence mounted in the other apparatus. In a case where the function, the service, or the like is not offered by the artificial intelligence, the processing is finished since a check test need not be executed. In a case where the function, the service, or the like is offered by the artificial intelligence, processes in step S11 and subsequent steps are executed. The same applies to a second example and subsequent examples.

In a case where a check test has been already executed (Yes in S11), i.e., in a case where the artificial intelligence has already answered the check test, the test executing unit 26 checks whether or not a predetermined period (e.g., a certain period) has elapsed from a time of execution of the check test (S12).

In a case where the predetermined period has not elapsed from the time of execution of the check test (No in S12), the processing is finished.

In a case where the predetermined period has elapsed from the time of execution of the check test (Yes in S12), the test executing unit 26 executes the check test again (S13). That is, the test executing unit 26 causes the artificial intelligence to answer the check test again. In a case where the check test has not been executed (No in S11), the test executing unit 26 executes the check test (S13).

In a case where the check test is executed and it is determined that performance of the artificial intelligence satisfies a predetermined criterion (Yes in S14), the processing shifts to step S12.

In a case where the check test is executed and it is not determined that performance of the artificial intelligence satisfies the predetermined criterion (No in S14), the artificial intelligence controller 30 restricts operation of the artificial intelligence (S15).

Furthermore, the test executing unit 26 may execute the check test in a case where learning data to be learned by the artificial intelligence is changed or in a case where an algorithm of the artificial intelligence is changed.

The test executing unit 26 may check repeatability of an answer by executing the check test successively or at predetermined time intervals.

The controller 28 of the terminal apparatus 10 may cause warning information (e.g., information indicating that the check test is to be executed, information indicating that the check test has not been executed) to be displayed on a display of the UI unit 20 of the terminal apparatus 10 before execution of the check test. In this case, the test executing unit 26 may execute the check test in a case where a user gives an instruction to execute the check test by operating the UI unit 20 of the terminal apparatus 10. Needless to say, the test executing unit 26 may execute the check test without a user's instruction. For example, the test executing unit 26 may execute the check test after elapse of a predetermined period from a time at which the warning information is displayed.

In a case where it is not determined that performance of the artificial intelligence satisfies the predetermined criterion without displaying the warning information on the display of the UI unit 20, the controller 28 of the terminal apparatus 10 may cause warning information indicative of this determination to be displayed on the display of the UI unit 20. For example, the controller 28 may cause information prompting the user to stop use of the artificial intelligence to be displayed on the display of the UI unit 20.

### Second Example

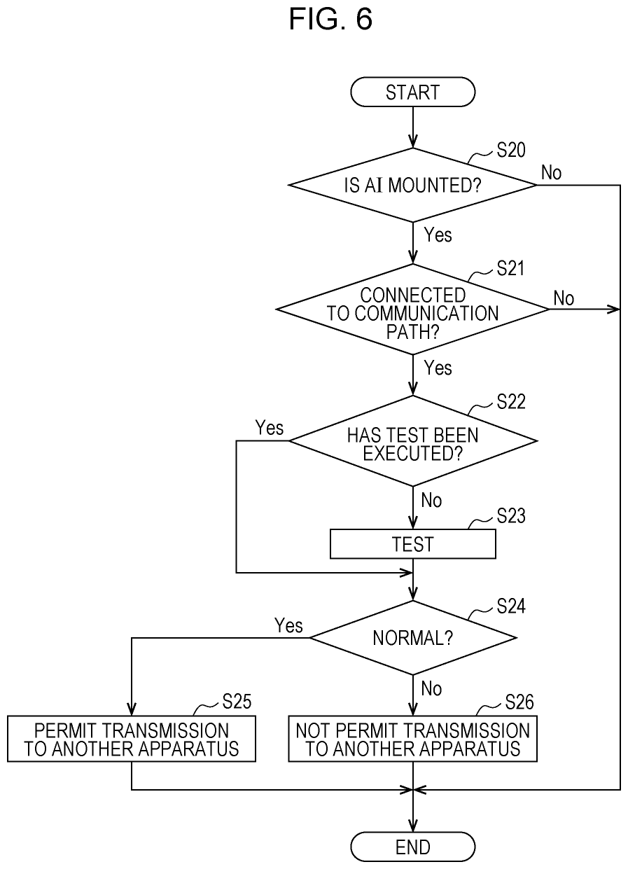

Processing according to a second example is described with reference to FIG. 6. FIG. 6 is a flowchart illustrating processing according to the second example. In the second example, a matter considered as the environment of the terminal apparatus 10 is “communication”.

First, the test executing unit 26 checks whether or not artificial intelligence (“AI” in FIG. 6) is mounted in the terminal apparatus 10 (S20).

In a case where artificial intelligence is not mounted in the terminal apparatus 10 (No in S20), the processing is finished since a check test need not be executed.

In a case where artificial intelligence is mounted in the terminal apparatus 10 (Yes in S20), the test executing unit 26 checks whether or not the terminal apparatus 10 is connected to the communication path N (S21). In this example, the communication path N is, for example, the Internet, and the test executing unit 26 checks whether or not the terminal apparatus 10 is connected to the Internet.

In a case where the terminal apparatus 10 is connected to the Internet (Yes in S21), the test executing unit 26 checks whether or not a check test has been already executed (S22). That is, the test executing unit 26 checks whether or not the artificial intelligence has already answered to a check test.

The check test is a global-standard check test, and the test executing unit 26 checks whether or not the global-standard check test has been already executed. The global-standard check test is a test for checking whether or not no problem occurs even in a case where information is sent worldwide and is, for example, a test for checking whether or not the artificial intelligence can correctly make a judgment concerning cultures, race, sex, and the like in countries. For example, the global-standard check test includes a test for checking information such as information that may be sent and information that should not be sent concerning consideration elements such as cultures, race, and sex. For example, the global-standard check test may include a test for checking whether or not the artificial intelligence can correctly make a judgment, for example, concerning a discriminatory expression.

The global-standard check test may be, for example, a check test for Internet. Since information can be sent worldwide by using the Internet, it can be checked whether or not information sent worldwide by the artificial intelligence causes a problem by conducting a test by using the check test for Internet.

In a case where the terminal apparatus 10 is connected to the Internet, the transmitting unit 16 of the terminal apparatus 10 transmits information requesting acquisition of data of the global-standard check test to the determining apparatus 12. The data of the global-standard check test is transmitted from the determining apparatus 12 to the terminal apparatus 10 in response to the request.

In a case where the terminal apparatus 10 is not connected to the Internet (No in S21), the processing is finished.

In a case where the global-standard check test has not been executed (No in S22), i.e., in a case where the artificial intelligence has not answered the global-standard check test, the test executing unit 26 executes the global-standard check test (S23).

In a case where the global-standard check test and it is determined that performance of the artificial intelligence satisfies a predetermined criterion (Yes in S24), the artificial intelligence controller 30 permits the artificial intelligence to send information to an apparatus other than the terminal apparatus 10 (S25). Similarly, in a case where the global-standard check test has been already executed (Yes in S22) and it is determined that performance of the artificial intelligence satisfies a predetermined criterion (Yes in S24), the artificial intelligence controller 30 permits the artificial intelligence to send information to another apparatus (S25). For example, the artificial intelligence controller 30 permits the artificial intelligence to send information to another apparatus over the Internet.

In a case where it is not determined that performance of the artificial intelligence satisfies the predetermined criterion (No in S24), the artificial intelligence controller 30 does not permit the artificial intelligence to send information to another apparatus (S26). For example, the artificial intelligence controller 30 does not permit the artificial intelligence to send information to another apparatus over the Internet. This can prevent information that can cause a problem in a case where the information is sent worldwide from being sent over the Internet.

### Third Example

A third example is described below.

In the third example, plural artificial intelligences work in cooperation with one another. All of the plural artificial intelligences that work in cooperation with one another may be mounted in the terminal apparatus 10 or may be mounted in another apparatus (e.g., a server) other than the terminal apparatus 10. One or more of the plural artificial intelligences that work in cooperation with one another may be mounted in the terminal apparatus 10 and the other artificial intelligences may be mounted in another apparatus.

The work conducted by the plural artificial intelligences in cooperation with one another may be any work. For example, the plural artificial intelligences may execute processes allocated to the plural artificial intelligences. Alternatively, the plural artificial intelligences execute different processes, and finally processing results of the plural artificial intelligences may be collectively output.

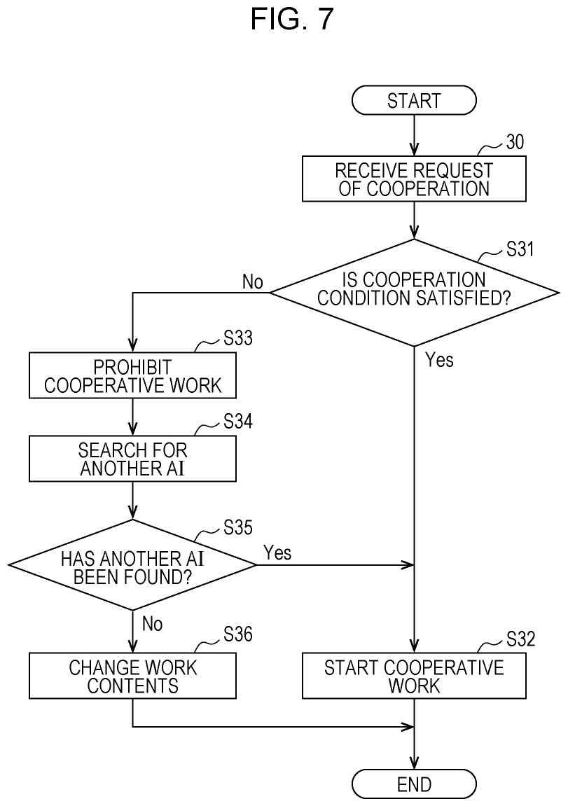

Processing according to the third example is described below with reference to FIG. 7. FIG. 7 is a flowchart illustrating the processing according to the third example.

First, when a user requests execution of cooperative work by operating the UI unit 20 of the terminal apparatus 10, the controller 28 of the terminal apparatus 10 receives the request (S30). For example, the user designates contents of the work and plural artificial intelligences that execute the work in cooperation with one another and further gives an instruction to execute the cooperative work by operating the UI unit 20. In another example, work and plural artificial intelligences that execute the work in cooperation with one another may be associated in advance. In this case, when the user designates work, the controller 28 specifies plural artificial intelligences associated with the work as plural artificial intelligences that execute the work in cooperation with one another.

In a case where a difference in performance among the plural artificial intelligences satisfies a cooperation condition (Yes in S31), the artificial intelligence controller 30 permits the plural artificial intelligences to execute the cooperative work. This allows the plural artificial intelligences to start the cooperative work (S32).

In a case where the difference in performance does not satisfy the cooperation condition (No in S31), the artificial intelligence controller 30 prohibits the plural artificial intelligences from executing the cooperative work (S33). In this case, the plural artificial intelligences do not execute the work in cooperation with one another. Note that the artificial intelligence controller 30 may restrict the cooperative work without prohibiting the plural artificial intelligences from executing the cooperative work. For example, the artificial intelligence controller 30 may permit part of the cooperative work and prohibit other part of the cooperative work.

The case where the difference in performance satisfies the cooperation condition is, for example, a case where the difference in performance among the plural artificial intelligences is less than a predetermined threshold value. The case where the difference in performance does not satisfy the cooperation condition is a case where the difference in performance is equal to or larger than the threshold value.

In order to determine whether or not the difference in performance satisfies the cooperation condition, the test executing unit 26 causes each of the plural artificial intelligences that work in cooperation with one another to answer a check test. The artificial intelligences answer, for example, the same check test. The artificial intelligences may answer different check tests in accordance with works allocated to the artificial intelligences. The check test may be a test according to the work executed by the plural artificial intelligences in cooperation with one another (i.e., a test for checking whether or not the plural artificial intelligences are suitable for the work). Answer information indicative of an answer of each artificial intelligence is transmitted from the terminal apparatus 10 to the determining apparatus 12.

The evaluating unit 42 evaluates performance of each artificial intelligence on the basis of the answer of the artificial intelligence and further determines whether or not the difference in performance among the plural artificial intelligences is equal to or larger than the threshold value. Specifically, the evaluating unit 42 determines whether or not the difference in performance is equal to or larger than the threshold value on the basis of a score of the answer of each artificial intelligence. In this example, it is assumed that a higher score indicates higher performance.

For example, in a case where a difference between a highest score and a lowest score among the scores of the plural artificial intelligences is equal to or larger than a threshold value, the evaluating unit 42 determines that the difference in performance among the plural artificial intelligences is equal to or larger than the threshold value. In a case where the difference between the highest score and the lowest score is less than the threshold value, the evaluating unit 42 determines that the difference in performance among the artificial intelligences is less than the threshold value. Note that the evaluating unit 42 may determine whether or not the difference in performance among the plural artificial intelligences is equal to or larger than the threshold value on the basis of a difference between a second highest score and a second lowest score while excluding the highest score and the lowest score. Needless to say, the evaluating unit 42 may evaluate the difference in performance by a different method. For example, the evaluating unit 42 may calculate an average of the scores of the plural artificial intelligences and determine whether or not the difference in performance satisfies the cooperation condition on the basis of a difference between the score of each artificial intelligence and the average.

Evaluation result information (i.e., information indicating whether or not performance of the plural artificial intelligences that work in cooperation with one another satisfies the cooperation condition) indicative of a result of the evaluation of the evaluating unit 42 is transmitted from the determining apparatus 12 to the terminal apparatus 10. The artificial intelligence controller 30 causes the plural artificial intelligences to execute the work in cooperation with one another or prohibits the plural artificial intelligences from executing the cooperative work in accordance with the evaluation result.

The evaluating unit 42 may evaluate performance of the plural artificial intelligences that work in cooperation with one another in a field of the cooperative work. That is, the evaluating unit 42 determines whether or not the difference in performance among the plural artificial intelligences satisfies a cooperation condition concerning the field of the cooperative work. Even in a case where the difference in performance does not satisfy a cooperation condition concerning a field other than the field of the cooperative work, the evaluating unit 42 determines that the difference in performance satisfies the cooperation condition in a case where the difference in performance satisfies the cooperative condition concerning the field of the cooperative work. In this case, the plural artificial intelligences start the cooperative work concerning the field.

In another example, in a case where the plural artificial intelligences that work in cooperation with one another include artificial intelligence that does not have performance equal to or higher than predetermined performance, the artificial intelligence controller 30 may prohibit the plural artificial intelligences from executing the cooperative work (S33). In a case where the artificial intelligence that does not have performance equal to or higher than the predetermined performance is not included in the plural artificial intelligences, the artificial intelligence controller 30 permits the plural artificial intelligences to execute the cooperative work. This allows the plural artificial intelligences to start the cooperative work (S32).

For example, in a case where an answer of artificial intelligence satisfies an acceptance criterion concerning the global-standard check test or in a case where the answer of the artificial intelligence satisfies an acceptance criterion concerning the field of the work, the evaluating unit 42 determines that the artificial intelligence has performance equal to or higher than the predetermined performance. In a case where an answer of artificial intelligence does not satisfy the acceptance criterion concerning the global-standard check test or in a case where the answer of the artificial intelligence does not satisfy the acceptance criterion concerning the field of the work, the evaluating unit 42 determines that the artificial intelligence does not have performance equal to or higher than the predetermined performance.

Processes in step S34 and subsequent steps are described below.

The controller 28 searches for another artificial intelligence for which the difference in performance satisfies the cooperation condition (S34). The controller 28 searches for another artificial intelligence for which the difference in performance satisfies the cooperation condition, for example, from among artificial intelligences present within a predetermined search range. In this case, the test executing unit 26 causes each artificial intelligence to answer a check test, and the controller 28 searches for one or more artificial intelligences for which the difference in performance satisfies the cooperation condition on the basis of an evaluation result based on each answer. The controller 28 may search for another artificial intelligence having performance whose difference from the performance that has been already determined in step S31 satisfies the cooperation condition or may search for new plural artificial intelligences for which a difference in performance satisfies the cooperation condition. The search range is, for example, a network to which the terminal apparatus 10 is permitted to be connected.

In another example, in a case where the plural artificial intelligences that work in cooperation with one another include artificial intelligence that does not have performance equal to or higher than the predetermined performance, the controller 28 may search for another artificial intelligence that has performance equal to or higher than the predetermined performance.

In a case where another artificial intelligence for which a difference in performance satisfies the cooperation condition is found (Yes in S35), the processing shifts to step S32. More specifically, in a case where another artificial intelligence for which a difference in performance satisfies the cooperation condition is found and artificial intelligences needed to execute the cooperative work to be executed are prepared, the processing shifts to step S32. For example, in a case where another artificial intelligence for which a difference in performance satisfies the cooperation condition is found within a predetermined period from start of the search, the processing shifts to step S32.

In another example, in a case where another artificial intelligence that has performance equal to or higher than the predetermined performance is found (Yes in S35), the processing may shift to step S32. More specifically, in a case where another artificial intelligence that has performance equal to or higher than the predetermined performance is found and artificial intelligences needed to execute the cooperative work to be executed are prepared, the processing shifts to step S32.

In a case where another artificial intelligence for which a difference in performance satisfies the cooperation condition is not found (No in S35), the artificial intelligence controller 30 changes contents of the cooperative work (S36). For example, the artificial intelligence controller 30 changes contents of the work to contents of work that can be executed in combination by the plural artificial intelligences (i.e., the originally designated plural artificial intelligences) for which it is determined in step S31 that the difference in performance does not satisfy the cooperation condition.

In another example, in a case where another artificial intelligence that has performance equal to or higher than the predetermined performance is not found (No in S35), the artificial intelligence controller 30 changes contents of the cooperative work (S36). For example, the artificial intelligence controller 30 changes contents of the work to contents of work that can be executed by the originally designated plural artificial intelligences in cooperation.

In a case where the contents of the work are changed and the plural artificial intelligences execute changed work in cooperation, the controller 28 of the terminal apparatus 10 may search for another artificial intelligence for which a difference in performance satisfies the cooperation condition or another artificial intelligence that has performance equal to or higher than the predetermined performance. In a case where another artificial intelligence is found, the artificial intelligence controller 30 may cause the plural artificial intelligences to execute the work before the change.

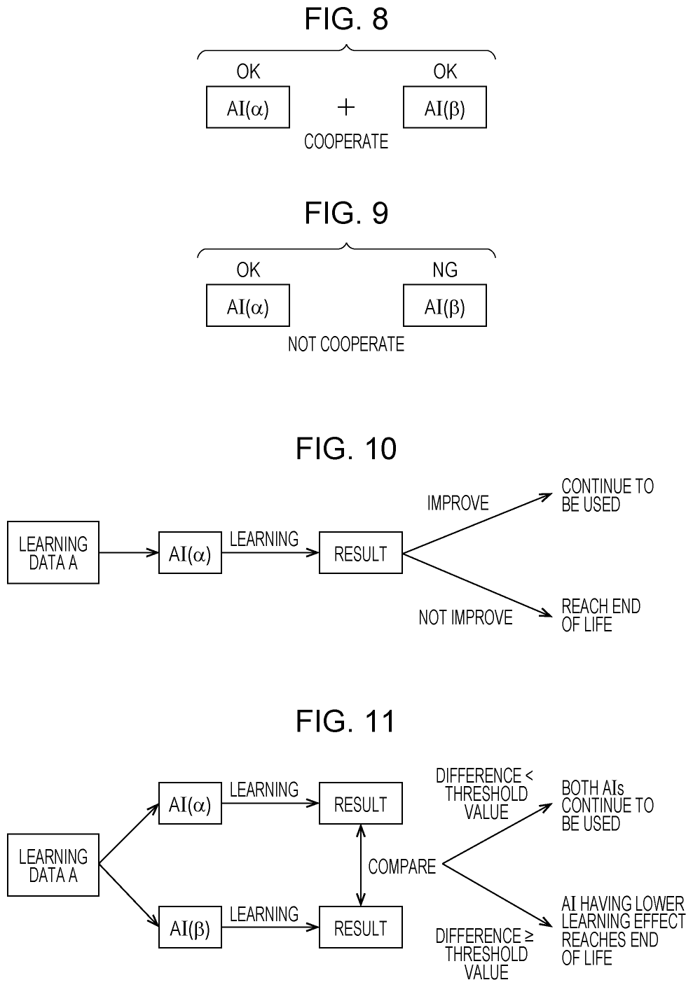

An example of the third example is described with reference to FIGS. 8 and 9.

As illustrated in FIG. 8, in a case where artificial intelligence α (AI (α) in FIGS. 8 and 9) has performance equal to or higher than predetermined performance and artificial intelligence β (AI (β) in FIGS. 8 and 9) has performance equal to or higher than the predetermined performance, the artificial intelligences α and β work in cooperation with each other.

As illustrated in FIG. 9, in a case where the artificial intelligence α has performance equal to or higher than the predetermined performance and the artificial intelligence β does not have performance equal to or higher than the predetermined performance, the artificial intelligences α and β do not work in cooperation with each other.

Such an arrangement is also possible in which in a case where a difference in performance between the artificial intelligences α and β is less than a threshold value, the artificial intelligences α and β work in cooperation with each other, whereas in a case where the difference in performance between the artificial intelligences α and β is equal to or larger than the threshold value, the artificial intelligences α and β do not work in cooperation with each other.

Modifications are described below.

### First Modification

A first modification is described below. In the first modification, in a case where performance of artificial intelligence becomes equal to or higher than predetermined upper-limit performance as a result of learning of the artificial intelligence or in a case where performance of the artificial intelligence becomes equal to or lower than predetermined lower-limit performance as a result of learning of the artificial intelligence, the artificial intelligence controller 30 restricts operation of the artificial intelligence. The artificial intelligence controller 30 may stop learning of the artificial intelligence. Furthermore, the controller 28 may output warning information indicating that the performance of the artificial intelligence has become equal to or higher than the upper-limit performance or warning information indicating that the performance of the artificial intelligence has become equal to or lower than the lower-limit performance. For example, the controller 28 may cause the warning information to be displayed on the display of the UI unit 20. The upper-limit performance and the lower-limit performance may be designated by a user.

Learning data is used for learning of artificial intelligence, and the artificial intelligence learns the learning data. The learning data may be data including a correct judgment (i.e., an answer) as learning data used for supervised learning or may be data that does not include a correct judgment as learning data used for unsupervized learning. The learning data is, for example, document data (e.g., text data), image data (e.g., still image data or moving image data), music data, audio data, or a combination thereof, and kind, data format, and contents thereof are not limited in particular. The learning data is stored in the terminal apparatus 10, the determining apparatus 12, or another apparatus (e.g., a server). To cause artificial intelligence to learn learning data, the artificial intelligence controller 30 acquires the learning data from an apparatus in which the learning data is stored and causes the artificial intelligence to learn the learning data.

For example, a junior high school level, a high school level, a Japanese working people level, an American working people level, or the like is set as the upper-limit performance and lower-limit performance, and the test executing unit 26 causes artificial intelligence to answer a check test according to the set level. Needless to say, a level other than these levels may be set. Note that data of check tests according to the respective levels is stored in the determining apparatus 12.

The evaluating unit 42 determines whether or not performance of artificial intelligence has become equal to or higher than the upper-limit performance by evaluating an answer of the artificial intelligence to the check test according to the set level. Evaluation result information indicative of a result of the determination is transmitted from the determining apparatus 12 to the terminal apparatus 10.

Similarly, the evaluating unit 42 determines whether or not performance of artificial intelligence has become equal to or lower than the lower-limit performance by evaluating an answer of the artificial intelligence to the check test according to the set level. Evaluation result information indicative of a result of the determination is transmitted from the determining apparatus 12 to the terminal apparatus 10.

In a case where it is determined that the performance of the artificial intelligence has become equal to or higher than the upper-limit performance, the artificial intelligence controller 30 restricts operation of the artificial intelligence. This makes it possible to prevent artificial intelligence having performance equal to or higher than the upper-limit performance from operating. For example, it is possible to prevent the artificial intelligence from performing operation that is not intended by the user or operation that cannot be predicted by the user.

In a case where it is determined that the performance of the artificial intelligence has become equal to or lower than the lower-limit performance, the artificial intelligence controller 30 restricts operation of the artificial intelligence. This makes it possible to prevent the artificial intelligence having performance equal to or lower than the lower-limit performance from operating. For example, it is possible to prevent the artificial intelligence from performing operation that is not intended by the user or operation that cannot be predicted by the user.

In another example, in a case where it is determined that the performance of the artificial intelligence has become equal to or higher than the upper-limit performance, the artificial intelligence controller 30 may stop learning of the artificial intelligence without restricting operation of the artificial intelligence or while restricting operation of the artificial intelligence. This makes it possible to prevent further improvement of the performance of the artificial intelligence having performance equal to or higher than the upper-limit performance. For example, it is possible to prevent artificial intelligence having performance that is not intended by the user or performance that cannot be predicted by the user from being created.

Similarly, in a case where it is determined that the performance of the artificial intelligence has become equal to or lower than the lower-limit performance, the artificial intelligence controller 30 may stop learning of the artificial intelligence without restricting operation of the artificial intelligence or while restricting operation of the artificial intelligence. This makes it possible to prevent further decrease of the performance of the artificial intelligence having performance equal to or lower than the lower-limit performance. For example, it is possible to prevent artificial intelligence having performance that is not intended by the user or performance that cannot be predicted by the user from being created.

In another example, in a case where it is determined that the performance of the artificial intelligence has become equal to or higher than the upper-limit performance, the artificial intelligence controller 30 may cause the artificial intelligence to learn learning data that is predicted to decrease the performance of the artificial intelligence without restricting operation of the artificial intelligence or while restricting the performance of the artificial intelligence. For example, the artificial intelligence controller 30 causes the artificial intelligence to learn learning data that is predicted to make the performance of the artificial intelligence less than the upper-limit performance. This makes it possible to keep the performance of the artificial intelligence at performance that is intended by the user or performance that can be predicted by the user.

In a case where it is determined that the performance of the artificial intelligence has become equal to or lower than the lower-limit performance, the artificial intelligence controller 30 may cause the artificial intelligence to learn learning data that is predicted to improve the performance of the artificial intelligence without restricting operation of the artificial intelligence or while restricting operation of the artificial intelligence. For example, the artificial intelligence controller 30 causes the artificial intelligence to learn learning data that is predicted to make the performance of the artificial intelligence higher than the lower-limit performance. This makes it possible to keep the performance of the artificial intelligence at performance that is intended by the user or performance that can be predicted by the user.

Note that the artificial intelligence controller 30 may cause the artificial intelligence to learn learning data that is predicted to make the performance of the artificial intelligence less than the upper-limit performance and make the performance of the artificial intelligence higher than the lower-limit performance.

In another example, the artificial intelligence controller 30 may stop learning of the artificial intelligence without restricting operation of the artificial intelligence or while restricting operation of the artificial intelligence in a case where the performance of the artificial intelligence is about to become equal to or higher than the upper-limit performance. For example, performance that is slightly lower than the upper-limit performance is set as a threshold value, and the artificial intelligence controller 30 stops learning of the artificial intelligence in a case where the performance of the artificial intelligence has become equal to or higher than the threshold value. This makes it possible to prevent artificial intelligence having performance equal to or higher than the upper-limit performance from being created. For example, in a case where a high school level is set as the upper-limit performance, it is possible to prevent artificial intelligence having performance equal to or higher than the high school level from being created.

In a case where the performance of the artificial intelligence is about to become equal to or lower than the lower-limit performance, the artificial intelligence controller 30 may stop learning of the artificial intelligence without restricting operation of the artificial intelligence or while restricting operation of the artificial intelligence. For example, performance that is slightly higher than the lower-limit performance is set as a threshold value, and the artificial intelligence controller 30 stops learning of the artificial intelligence in a case where the performance of the artificial intelligence has become equal to or lower than the threshold value. This makes it possible to prevent artificial intelligence having performance equal to or lower than the lower-limit performance from being created. For example, in a case where a high school level is set as the lower-limit performance, it is possible to prevent artificial intelligence having performance equal to or lower than the high school level from being created.

### Second Modification

A second modification is described below. In the second modification, the artificial intelligence controller 30 determines end of life of artificial intelligence. The “end of life” as used herein means that performance of artificial intelligence does not improve even in a case where the artificial intelligence learns learning data or that even in a case where the performance of the artificial intelligence improves, the improvement is less than a threshold value. Determination that artificial intelligence has reached end of life is used as a criterion for prompting a user to exchange the artificial intelligence or change an algorithm.

For example, as illustrated in FIG. 10, the artificial intelligence controller 30 causes artificial intelligence α to learn learning data A that has not been learned by the artificial intelligence α and determines whether or not the performance of the artificial intelligence α has improved as a result of the learning. In a case where the performance of the artificial intelligence α has improved, the artificial intelligence controller 30 determines that the artificial intelligence α has not reached end of life. In a case where the performance of the artificial intelligence α has not improved, the artificial intelligence controller 30 determines that the artificial intelligence α has reached end of life. Even in a case where the performance of the artificial intelligence α has improved, the artificial intelligence controller 30 may determine that the artificial intelligence α has reached end of life in a case where the improvement is less than a threshold value.

In a case where it is determined that the artificial intelligence α has reached end of life, the controller 28 may output information such as information indicating that the artificial intelligence α has reached end of life, information indicative of recommendation to exchange the artificial intelligence, or information indicative of recommendation to change an algorithm of the artificial intelligence. For example, the controller 28 may cause the information indicating that the artificial intelligence α has reached end of life or information indicative of the recommendation to be displayed on the display of the UI unit 20 or may output voice.

Note that the artificial intelligence controller 30 may cause the artificial intelligence α to learn the same learning data plural times successively or at predetermined time intervals and determine the end of life of the artificial intelligence α on the basis of a result of the learning.

The artificial intelligence controller 30 may cause the artificial intelligence α to learn plural pieces of different learning data and determine the end of life of the artificial intelligence α on the basis of a result of the learning. For example, in a case where the number of pieces of learning data that have improved the performance of the artificial intelligence α is less than a threshold value, the artificial intelligence controller 30 determines that the artificial intelligence α has reached end of life. In a case where the number of pieces of learning data that have improved the performance of the artificial intelligence α is equal to or larger than the threshold value, the artificial intelligence controller 30 determines that the artificial intelligence α has not reached end of life.

FIG. 11 illustrates another example. In the other example, as illustrated in FIG. 11, the artificial intelligence controller 30 causes each of artificial intelligences α and β to learn learning data A that has not been learned by each of the artificial intelligences α and β and compares a result of the learning of the artificial intelligence α and a result of the learning of the artificial intelligence β. In a case where a different between the result of the learning of the artificial intelligence α and the result of the learning of the artificial intelligence β is less than a threshold value, the artificial intelligence controller 30 determines that each of the artificial intelligences α and β has not reached end of life. In a case where the different between the result of the learning of the artificial intelligence α and the result of the learning of the artificial intelligence β is equal to or larger than the threshold value, the artificial intelligence controller 30 determines that artificial intelligence having a lower learning effect among the artificial intelligences α and β has reached end of life. The artificial intelligence having a lower learning effect is artificial intelligence whose performance has not improved as compared with performance of the other artificial intelligence, artificial intelligence whose performance has not improved while performance of the other artificial intelligence has improved, or artificial intelligence whose performance has decreased more than the performance of the other artificial intelligence although the performance of the other artificial intelligence has decreased.

The artificial intelligences α and β may be artificial intelligences having the same or similar learning history or may be artificial intelligences having learning histories that are not the same nor similar. A case where the learning histories are similar is a case where a difference between the learning history of the artificial intelligence α and the learning history of the artificial intelligence β is less than a threshold value.

### Third Modification

A third modification is described below. In the third modification, the artificial intelligence controller 30 may determine an effect given to artificial intelligence by learning data for each function of the artificial intelligence and create management information (e.g., database) for managing a result of the determination. The management information may be stored in the storage unit 22 of the terminal apparatus 10, may be stored in the storage unit 40 of the determining apparatus 12, or may be stored in another apparatus such as a server. This determining process may be performed by the evaluating unit 42 of the determining apparatus 12. The artificial intelligence subjected to the determination may be mounted in the terminal apparatus 10 or may be mounted in another apparatus such as a server.

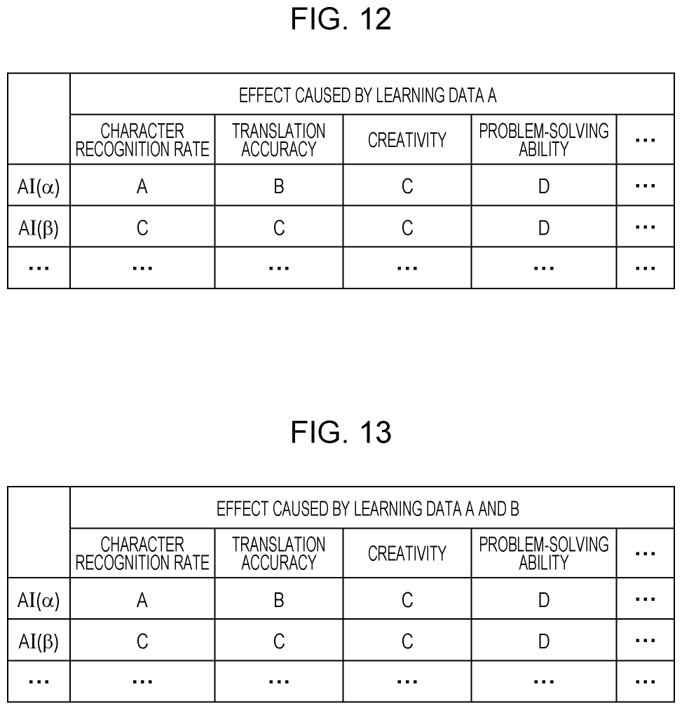

FIG. 12 illustrates an example of a database that is an example of the management information. The database illustrated in FIG. 12 is a database indicative of a result of determination about an effect given to the artificial intelligence by learning data A. In this database, information indicative of a result of determination about an effect given to each artificial intelligence by the learning data A is managed for each function of the artificial intelligence.

For example, artificial intelligence α and artificial intelligence β each has functions such as a character recognition function, a translation function, creativity, and problem-solving ability. A determination result A indicates that performance has improved markedly. A determination result B indicates that performance has improved slightly. A determination result C indicates that performance has not changed. A determination result D indicates that performance has decreased.

As a result of learning of the learning data A, a character recognition rate of the artificial intelligence α has improved markedly, translation accuracy of the artificial intelligence α has improved slightly, creativity of the artificial intelligence α has not changed, and problem-solving ability of the artificial intelligence α has decreased. That is, performance of the character recognition function of the artificial intelligence α has improved markedly, performance of the translation function of the artificial intelligence α has improved slightly, performance of the creativity of the artificial intelligence α has not changed, and performance of the problem-solving ability of the artificial intelligence α has decreased.

As a result of learning of the learning data A, a character recognition rate, translation accuracy, and creativity of the artificial intelligence β have not changed, and problem-solving ability of the artificial intelligence β has decreased. That is, performance of the character recognition function, translation function, and creativity of the artificial intelligence β has not changed, and performance of the problem-solving ability of the artificial intelligence β has decreased.

Since determination results are managed as described above, an effect given to performance of each artificial intelligence by learning data can be evaluated. In the example illustrated in FIG. 12, comparison between the artificial intelligence α and the artificial intelligence β shows that the performance of the artificial intelligence β has not improved as compared with the performance of the artificial intelligence α although both of the artificial intelligence α and the artificial intelligence β learn the same learning data A. In other words, the comparison shows that the performance of the artificial intelligence α has improved as compared with the performance of the artificial intelligence β.

Since there is sometimes a difference in learning history between the artificial intelligence α and the artificial intelligence β, it may be said that an effect given to performance of artificial intelligences by the learning data A cannot be necessarily judged only from the determination results. However, the determination results can be used as one index for evaluating an effect given to performance of the artificial intelligences by the learning data A.

Furthermore, in a case where learning histories of artificial intelligences are managed, it can be estimated what learning history artificial intelligence whose performance can be improved by learning of the learning data A has. For example, in a case where the artificial intelligence α and the artificial intelligence β use the same algorithm, it can be estimated what learning history artificial intelligence whose performance can be improved by learning of the learning data A has.

Furthermore, in a case where the artificial intelligence α and the artificial intelligence β use different algorithms, an algorithm by which performance of artificial intelligence improves as a result of learning of the learning data A can be estimated. In the example illustrated in FIG. 12, the performance of the artificial intelligence α improves as compared with the performance of the artificial intelligence β, and therefore it can be estimated that the algorithm by which performance of artificial intelligence improves as a result of learning of the learning data A is the algorithm used by the artificial intelligence α.

Furthermore, in a case where an algorithm used by artificial intelligence, a time of start of use, a time of start of learning, and a learning period of the artificial intelligence, and the like are managed as a database for each artificial intelligence, it can be estimated whether a factor of an effect given to artificial intelligence by learning of learning data is the learning data or a reason (e.g., an algorithm or a learning history) other than the learning data.

The artificial intelligence controller 30 may determine, for each function of artificial intelligence, an effect given to the artificial intelligence by a combination of plural pieces of learning data and create management information (e.g., database) for managing a result of the determination.

FIG. 13 illustrates an example of a database that is an example of the management information. The database illustrated in FIG. 13 is a database indicative of a result of determination about an effect given to artificial intelligence by a combination of learning data A and B. In this database, information indicative of a result of determination about an effect given to each artificial intelligence by a combination of learning data A and B is managed for each function of the artificial intelligence. The meanings of determination results A, B, C, and D are the same as the meanings of the determination results illustrated in FIG. 12.

As a result of learning of the combination of the learning data A and B, a character recognition rate of the artificial intelligence α has improved markedly, translation accuracy of the artificial intelligence α has improved slightly, creativity of the artificial intelligence α has not changed, and problem-solving ability of the artificial intelligence α has decreased. That is, performance of a character recognizing function of the artificial intelligence α has improved markedly, performance of a translation function of the artificial intelligence α has improved slightly, performance of creativity of the artificial intelligence α has not changed, and performance of problem-solving ability of the artificial intelligence α has decreased.

As a result of learning of the combination of the learning data A and B, a character recognition rate, translation accuracy, and creativity of the artificial intelligence β have not changed, and problem-solving ability of the artificial intelligence β has decreased. That is, performance of a character recognizing function, a translation function, and creativity of the artificial intelligence β have not changed, and performance of problem-solving ability of the artificial intelligence β has decreased.

Since determination results are managed as described above, an effect given to performance of each artificial intelligence by a combination of plural pieces of learning data can be evaluated. In the example illustrated in FIG. 13, comparison between the artificial intelligence α and the artificial intelligence β shows that the performance of the artificial intelligence β has not improved as compared with the performance of the artificial intelligence α although both of the artificial intelligence α and the artificial intelligence β learn the same combination of the learning data A and B. In other words, the comparison shows that the performance of the artificial intelligence α has improved as compared with the performance of the artificial intelligence β.

In a case where artificial intelligence learns the learning data A and B in order, determination results obtained in a case where the order is changed may be managed in a database. That is, determination results obtained in a case where artificial intelligence learns the learning data A and B in an order of the learning data A and B and determination results obtained in a case where artificial intelligence learns the learning data A and B in an order of the learning data B and A may be managed in a database.

Although the artificial intelligence controller 30 causes artificial intelligence to learn a combination of two pieces of learning data in the above example, the artificial intelligence controller 30 may cause artificial intelligence to learn a combination of three or more pieces of learning data and determine an effect of the learning.

The pieces of learning data included in the combination of plural pieces of learning data may be learning data of the same kind or the same format or may be learning data of different kinds or different formats. For example, a combination of plural pieces of document data or a combination of plural pieces of image data may be used as the combination of plural pieces of learning data. Alternatively, a combination of document data and image data may be used as the combination of plural pieces of learning data. These combinations are merely examples, and the pieces of learning data included in the combination of plural pieces of learning data may be designated by a user.

Functions of the units of the terminal apparatus 10 and the determining apparatus 12 are realized, for example, by cooperation of hardware and software. Specifically, the terminal apparatus 10 and the determining apparatus 12 have one or more processors such as a CPU (not illustrated). The one or more processors read out and execute a program stored in a storage device (not illustrated), and thereby the functions of the units of the terminal apparatus 10 and the determining apparatus 12 are realized. The program is stored in the storage device through a recording medium such as a CD or a DVD or a communication path such as a network. In another example, the functions of the units of the terminal apparatus 10 and the determining apparatus 12 may be realized by a hardware resource such as a processor, an electronic circuit, or an application specific integrated circuit (ASIC). A device such as a memory may be used in realizing the functions of the units of the terminal apparatus 10 and the determining apparatus 12. In still another example, the functions of the units of the terminal apparatus 10 and the determining apparatus 12 may be realized, for example, by a digital signal processor (DSP) or a field programmable gate array (FPGA).

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a transmitting unit that transmits, to an external apparatus, environment information indicative of an environment of an apparatus that uses an artificial intelligence and checking information for checking estimation processing of the artificial intelligence;
a receiving unit that receives evaluation result information indicative of a result of evaluation of the estimation processing; and
a controller that sets the estimation processing active in a case where the result of the evaluation is compliant with the environment,
wherein a criterion for the evaluation of the estimation processing varies according to the environment indicated by the environment information.

2. The information processing apparatus according to claim 1, wherein
the receiving unit further receives test data representing contents of a test for checking performance of the artificial intelligence;
the transmitting unit transmits, as the checking information, answer information indicative of an answer of the artificial intelligence to the test to the external apparatus; and
the controller further restricts operation of the artificial intelligence in accordance with the answer.

3. The information processing apparatus according to claim 2, wherein
the test is executed again after a predetermined period has elapsed since the artificial intelligence last demonstrated performance that satisfies a predetermined criterion in the test.

4. The information processing apparatus according to claim 3, wherein
the test is automatically executed.

5. The information processing apparatus according to claim 2, wherein
the test is a test according to a field in which the artificial intelligence is used.

6. The information processing apparatus according to claim 3, wherein
the test is a test according to a field in which the artificial intelligence is used.

7. The information processing apparatus according to claim 4, wherein
the test is a test according to a field in which the artificial intelligence is used.

8. The information processing apparatus according to claim 5, wherein
the controller permits operation of the artificial intelligence only in a field in which performance of the artificial intelligence has satisfied a predetermined criterion of the test, among a plurality of fields.

9. The information processing apparatus according to claim 2, wherein
in a case where the receiving unit receives the test data, the test is executed even in a case where the artificial intelligence is executing operation other than answering the test.

10. The information processing apparatus according to claim 2, wherein
in a case where the test is not executed, the transmitting unit further transmits information concerning the artificial intelligence to the external apparatus.

11. The information processing apparatus according to claim 1, wherein
in a case where a plurality of artificial intelligences work in cooperation with one another, the controller further restricts the cooperative work of the plurality of artificial intelligences in a case where a difference in performance among the plurality of artificial intelligences is equal to or larger than a predetermined threshold value.

12. The information processing apparatus according to claim 1, wherein
in a case where a plurality of artificial intelligences work in cooperation with one another, the controller further restricts the cooperative work of the plurality of artificial intelligences in a case where the plurality of artificial intelligences include artificial intelligence that does not have performance equal to or higher than predetermined performance.

13. The information processing apparatus according to claim 1, wherein
the controller further restricts operation of the artificial intelligence in a case where performance of the artificial intelligence becomes equal to or higher than upper-limit performance as a result of learning of the artificial intelligence or in a case where the performance of the artificial intelligence becomes equal to or lower than lower-limit performance as a result of learning of the artificial intelligence.

14. The information processing apparatus according to claim 1, wherein
in a case where improvement of performance of the artificial intelligence is less than a predetermined threshold value as a result of learning of the artificial intelligence, the controller further outputs information indicating that the improvement of the performance of the artificial intelligence is less than the predetermined threshold value.

15. A non-transitory computer readable medium storing a program causing a computer to execute a process for information processing, the process comprising:
transmitting, to an external apparatus, environment information indicative of an environment of an apparatus that uses an artificial intelligence and checking information for checking estimation processing of the artificial intelligence;
receiving evaluation result information indicative of a result of evaluation of the estimation processing; and
setting the estimation processing active in a case where the result of the evaluation is compliant with the environment
wherein a criterion for the evaluation of the estimation processing varies according to the environment indicated by the environment information.

16. An information processing apparatus comprising:
transmitting means for transmitting, to an external apparatus, environment information indicative of an environment of an apparatus that uses an artificial intelligence and checking information for checking estimation processing of the artificial intelligence;
receiving means for receiving evaluation result information indicative of a result of evaluation of the estimation processing; and
controlling means for setting the estimation processing active in a case where the result of the evaluation is compliant with the environment,
wherein a criterion for the evaluation of the estimation processing varies according to the environment indicated by the environment information.
